(19) United States
(12) Patent Application Publication
(10) Pub. No.: US 2007/0090745 A1
(43) Pub. Date: Apr. 26, 2007

(54) Electron emission display

(75) Inventor: Eung-Joon Chi, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co.,Ltd., Suwon-si (KR)

(21) Appl. No.: 11/582,508

(22) Filed: Oct. 18, 2006

(30) Foreign Application Priority Data
Oct. 25, 2005 (KR) 10-2005-0100653

(51) Int. Cl. H01J 1/62; H01J 63/04; H01J 9/02

(52) U.S. Cl. 313/495; 313/310; 313/497

(57) ABSTRACT

An electron emission display includes first and second substrates facing each other, phosphor layers on the first substrate, and electron emission regions on the second substrate at each of unit pixel areas to correspond to the phosphor layers; spacers between some of the unit pixel areas to maintain a predetermined gap between the first and second substrates. The number of the electron emission regions in each unit pixel area adjacent to each spacer is greater than that of the electron emission regions in each unit pixel area that is not adjacent to the spacers to enhance the luminance and light emission uniformity of the electron emission display and to prevent abnormal light emission around the spacers.

### CROSS-REFERENCE TO RELATED APPLICATIONS

This application claims the benefit of Korean Application No. 2005-100653, filed Oct. 25, 2005, in the Korean Intellectual Property Office, the disclosure of which is incorporated herein by reference.

### BACKGROUND OF THE INVENTION

1. Field of the Invention

Aspects of the present invention relate to an electron emission display, and more particularly, to an electron emission display that can obviate a scan locus distortion problem by improving a structure of an electron emission region.

2. Description of the Related Art

Generally, electron emission elements are classified into those using hot cathodes as an electron emission source, and those using cold cathodes as the electron emission source. There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

The MIM element includes first and second metal layers and an insulation layer interposed between the first and second metal layers. The MIS element includes a metal layer, a semiconductor layer, and an insulation layer interposed between the metal layer and the semiconductor layer. In the MIM element, when a voltage is applied between the first and second metal layers, electrons generated from the first metal layer reach the second metal layer through the insulation layer by a tunneling phenomenon. Among the electrons reaching the second metal layer, some electrons each having energy higher than a work function of the second metal layer are emitted from the second metal layer. In the MIS element, when a voltage is applied between the metal layer and the semiconductor layer, electrons generated from the semiconductor layer reach the metal layer through the insulation layer by a tunneling phenomenon. Among the electrons reaching the metal layer, some electrons each having energy higher than a work function of the metal layer are emitted from the metal layer.

The SCE element includes first and second electrodes facing each other and a conductive layer disposed between the first and second electrodes. Fine cracks are formed on the conductive layer to form the electron emission regions. When a voltage is applied to the first and second electrodes to allow a current to flow along a surface of the conductive layer, electrons are emitted from the electron emission regions.

The FEA element includes an electron emission region and cathode and gate electrodes that are driving electrodes for controlling the electron emission from the electron emission region. The electron emission regions are formed of a material having a relatively low work function or a relatively large aspect ratio, such as a molybdenum-based material, a silicon-based material, and a carbon-based material such as carbon nanotubes, graphite, and diamond-like carbon so that electrons can be effectively emitted when an electric field is applied thereto under a vacuum atmosphere. When the electron emission regions are formed of the molybdenum-based material or the silicon-based material, they are formed in a pointed tip structure.

The electron emission elements are arrayed on a first substrate to form an electron emission device. The electron emission device is combined with a second substrate, on which a light emission unit having phosphor layers and an anode electrode is formed, to establish an electron emission display.

That is, the conventional electron emission device includes electron emission regions and a plurality of driving electrodes functioning as scan and data electrodes. By the operation of the electron emission regions and the driving electrodes, the on/off operation of each pixel and an amount of electron emission are controlled. The electron emission display excites phosphor layers using the electrons emitted from the electron emission regions to display a predetermined image.

The first and second substrates are sealed together at their peripheries using a sealing member and the inner space between the first and second substrates is exhausted to form a vacuum envelope. In addition, a plurality of spacers is disposed in the vacuum envelope to maintain a predetermined gap between the first and second substrates. The spacers are disposed at non-emission areas where a black layer is formed so as not to interfere with the electrons emitted from the electron emission regions.

The electron beam emitted from the electron emission region tends to be diffused as it travels. Therefore, the electron beam may collide with the spacers. By the collision of the electron beam with the spacers and the contact property of the spacers, the equipotential line around the electron emission region is distorted. As a result, the electrons may be attracted to or repulsed from the spacers along the distorted equipotential line.

The electron beam distortion causes the electrons to deviate from the normal landing portion of the phosphor layer. As a result, the non-emission area of the phosphor layer increases, thereby deteriorating the luminance and light emission uniformity of the electron emission display.

### SUMMARY OF THE INVENTION

Aspects of the present invention provide an electron emission display that can minimize the non-emission area of the phosphor layer, which may be formed by an electron beam distortion.

According to an aspect of the present invention, there is provided an electron emission display, including: first and second substrates facing each other; a plurality of phosphor layers formed on one substrate of the first and second substrates; a plurality of electron emission regions formed on another substrate of the first and second substrates at each of unit pixel areas to correspond to the phosphor layers; and a plurality of spacers disposed between the unit pixel areas to maintain a predetermined gap between the first and second substrates, wherein the number of the electron emission regions in each unit pixel area adjacent to each spacer is greater than that of the electron emission regions in each unit pixel area that is not adjacent to any of the spacers.

While not required in all aspects, the electron emission regions in each unit pixel area adjacent to each spacer may include main electron emission regions and at least one additional electron emission region. The additional electron emission region may be added while maintaining a same shape and distances between respective electron emission regions and openings as those of the main electron emission regions. The additional electron emission region may be added at a portion of the respective pixel area near the spacer. Alternatively, the additional electron emission region may be added at a portion far from the spacer.

While not required in all aspects, the phosphor layers may include red, green and blue phosphor layers corresponding to the respective unit pixel area, the red, green and blue phosphor layers being divided from each other by a black layer. The additional electron emission region may be formed to correspond to the black layer. The spacer may be formed in a wall-shape or a cylindrical-shape, although not limited thereto. That is, the shape of the spacer may be a wall shape extending in several directions at various angles, including perpendicular with openings disposed on either side thereof or only on one side. The electron emission region may be formed of a material selected from the group consisting of carbon nanotubes, graphite, graphite nanofibers, diamonds, diamond-like carbon, C₆₀, silicon nanowires, and a combination thereof.

According to another aspect of the present invention, there is provided an electron emission display, including: first and second substrates facing each other; cathode and gate electrodes formed on the first substrate to cross each other and insulated from each other; a plurality of electron emission regions connected to the cathode electrodes at crossed areas of the cathode and gate electrodes; a focusing electrode formed above the cathode and gate electrodes, the focusing electrode being provided with openings for exposing the electron emission regions; a plurality of phosphor layers formed on a surface of the second substrate facing the first substrate; a plurality of spacers disposed between some of the openings to maintain a predetermined gap between the first and second substrates, wherein the number of the electron emission regions formed in each opening adjacent to each spacer is greater than that of the electron emission regions formed in each opening that is not adjacent to any of the spacers.

While not required in all aspects electron emission regions in each opening adjacent to one of the spacers may include main electron emission regions and at least one additional electron emission region. The additional electron emission region may be added while maintaining a same shape and distances between respective electron emission regions and openings as those of the main electron emission region. The additional electron emission region may be added at a portion of the respective opening near the spacer or far from the spacer.

The spacer may be formed in a wall-shape extending in a direction parallel to one of the cathode and gate electrodes. Alternatively, the spacer may be formed in a cylindrical-shape and disposed between the two openings, although not required in all aspects. That is, the shape of the spacer is not particularly limited and may be a wall shape extending in several directions at various angles, including perpendicular with openings disposed on either side thereof or only on one side.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of an electron emission display according to an embodiment of the present invention;

FIG. 2 is a partial sectional view of the electron emission display shown in FIG. 1;

FIG. 3 a partial top view of the electron emission display shown in FIG. 1;

FIG. 4 is a partial top view of an electron emission display according to another embodiment of the present invention;

FIG. 5 is a partial top view of an electron emission display according to another embodiment of the present invention; and

FIG. 6 is a partial top view of an electron emission display according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

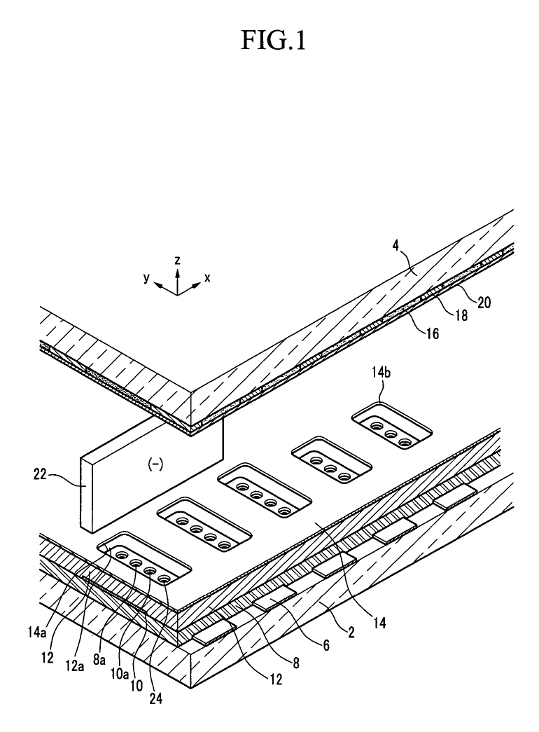

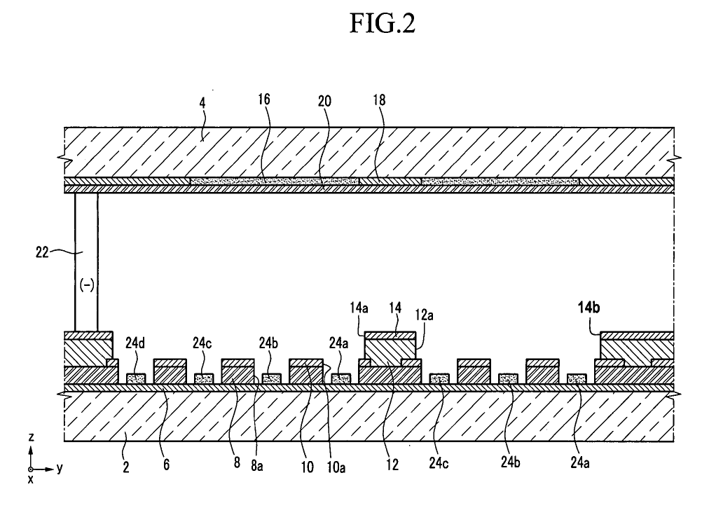

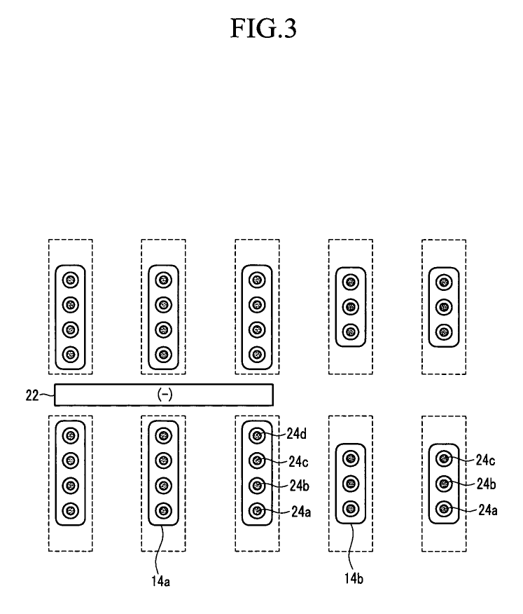

FIG. 1 is an exploded perspective view of an electron emission display according to an embodiment of the present invention, FIG. 2 is a partial sectional view of the electron emission display shown in FIG. 1, and FIG. 3 a partial top view of the electron emission display shown in FIG. 1. Referring to FIGS. 1 through 3, an electron emission display includes first and second substrates 2 and 4 facing each other at a predetermined interval. The first substrate 2 is provided with an electron emission unit while the second substrate 4 is provided with a light emission unit to emit light using electrons emitted from the electron emission unit.

That is, a plurality of cathode electrodes 6 is arranged on the first substrate 2 in a stripe pattern extending in a first direction (a direction of a y-axis in FIG. 1) and a first insulation layer 8 is formed on the first substrate 2 to cover the cathode electrodes 6. A plurality of gate electrodes 10 are arranged on the first insulation layer 8 in a stripe pattern extending in a second direction (a direction of an x-axis in FIG. 1) to cross the cathode electrodes 6 at right angles.

A second insulation layer 12 is formed on the first insulation layer while covering the gate electrodes 10 and a focusing electrode 14 is formed on the second insulation layer 12. When each crossed area of the cathode and gate electrodes 6 and 10 is defined as a unit pixel area (see dotted lines in FIG. 3), a plurality of openings 12a are formed on the second insulation layer 12 at the unit pixel area. A plurality of openings 14a and 14b corresponding to the openings 12a is also formed on the focusing electrode 14 at the unit pixel area. The openings 12a and 14a, 14b partially expose surfaces of the gate electrodes 10 to an external side.

The focusing electrode 14 is formed on an entire surface of the second insulation layer 12 as shown in FIG. 1. Alternatively, the focusing electrode 14 may be divided into a plurality of sections arranged in a predetermined pattern. A plurality of holes 8a is formed on each exposed portion of the first insulation layer 8 through the openings 12a and 14a. A plurality of holes 10a corresponding to the holes 8a is formed on the gate electrode 10. By the holes 8a and 10a, the cathode electrodes 6 are partly exposed.

Red (R), green (G) and blue (B) phosphor layers 16 corresponding to the unit pixel areas are formed on a surface of the second substrate 4 facing the first substrate 2 and a black layer 18 for enhancing a contrast of the screen is formed between the R, G and B phosphors 16. The R, G and B phosphor layers 16 define sub-pixels. The R, G and B phosphors 16 may be formed in a strip pattern.

An anode electrode 20 formed of a conductive material such as aluminum is formed on the phosphor and black layers 16 and 18. The anode electrode 20 functions to heighten the screen luminance by receiving a high voltage required for accelerating the electron beams and reflecting the visible rays radiated from the phosphor layers 16 to the first substrate 2 toward the second substrate 4.

Alternatively, the anode electrode may be formed of a transparent conductive material, such as Indium Tin Oxide (ITO), instead of the metallic material. In this case, the anode electrode is placed on the second substrate and the phosphor and black layers are formed on the anode electrode. In addition, the anode electrode is divided into a plurality of sections arranged in a predetermined pattern.

Disposed between the first and second substrates 2 and 4 are spacers 22 for uniformly maintaining a gap between the first and second substrates 2 and 4. In this embodiment, wall-shaped spacers are illustrated. The spacers 22 are arranged to correspond to a non-emission area where the black layer 18 is placed. To realize this, the spacers 22 are disposed on the focusing electrode 14 between some of the openings 14a. The spacers 22 may be arranged in parallel to the cathode or gate electrodes 6 and 10.

Electron emission regions 24 are formed on the cathode electrodes 6 through the holes 8a and 10a of the first insulation layer 8 and the gate electrodes 10. In this embodiment, the number M1 of the electron emission regions 24 disposed in each opening 14a of the focusing electrode 14, which is adjacent to each spacer 22, is greater than the number M2 of the electron emission regions 24 disposed in each opening 14b of the focusing electrode 14, which is not adjacent to any of the spacers 22 (M1>M2).

That is, referring to FIG. 2, three electron emission regions 24a, 24b and 24c are formed in each opening 14b of the focusing electrode 14, which is not adjacent to the spacer 22. To achieve this, three holes 8a are formed in the first insulation layer 8 in each opening 14b that is not adjacent to the spacer 22. Likewise, three holes 10a are formed in the gate electrode 10 in each opening 14b. The electron emission regions 24a, 24b and 24c are formed to correspond to the phosphor layers 16.

In addition, four electron emission regions 24a, 24b, 24c, and 24d are formed in each opening 14a of the focusing electrode 14, which is adjacent to each spacer 22. That is, one electron emission region 24 placed near the spacer 22 is added. To achieve this, four holes 8a are formed in the first insulation layer 8 in each opening 14a that is adjacent to each spacer 22. Likewise, four holes 10a are formed in the gate electrode 10 in each opening 14a. The electron emission regions 24a, 24b and 24c are formed to correspond to the phosphor layers 16. Therefore, a size of each opening 14a adjacent to the spacer 22 is greater than that of each opening 14b that is not adjacent to any of the spacers 22. The additional electron emission region 24d may be formed to correspond to the black layer 18. The additional electron emission region 24d is added while maintaining a same shape and distances between respective electron emission regions and openings as those of the main electron emission regions 24a, 24b, and 24c.

When the spacer 22 is charged with negative electric charge, the electron beam may be repulsed by the spacer 22 so as not to strike the target phosphor layer. However, in this embodiment, since the electron emission region 24d is added near the spacer 22, even when the spacer 22 is charged with the negative electric charge, the electron beam can land on the target phosphor layer.

In this embodiment, a case where only one electron emission region 24d is added has been described, however the present invention is not limited to such a case. The number and arrangement of the electron emission regions may vary according to the degree of the distortion of the electron beam. In addition, although a case is described where the electron emission regions 24 are formed in a circular shape and arranged in each opening 14a, 14b along a length of the cathode electrodes 6, the shape and arrangement of the electron emission regions and the number of the electron emission regions per unit pixel area are not limited to this case. FIG. 3 shows that four electron emission regions 24a, 24b, 24c, and 24d are formed in the openings 14a adjacent to the spacer 22 while three electron emission regions 24a, 24b, and 24c are formed in the openings 14b that are not adjacent to the spacer 22.

The electron emission regions 24 may be formed of a material, which emits electrons when an electric field is applied thereto under a vacuum atmosphere, such as a carbonaceous material or a nanometer-sized material. For example, the electron emission regions 24 may be formed of carbon nanotubes, graphite, graphite nanofibers, diamonds, diamond-like carbon, C60, silicon nanowires, or a combination thereof. The electron emission regions 24 may be formed through a direct-growth process, a screen-printing process, a chemical deposition process, or a sputtering process.

Meanwhile, although a case where the gate electrodes 10 are disposed above the cathode electrodes 6 with the first insulation layer 8 interposed therebetween is described, the present invention is not limited to this case. For example, the cathode electrodes 6 may be disposed above the gate electrodes 10 with the first insulation layer 8 interposed therebetween. In this case, the electron emission regions may be formed on the insulation layer while contacting the cathode electrodes. Additionally, according to aspects of the present invention, the electron emission display may not include the focusing electrode.

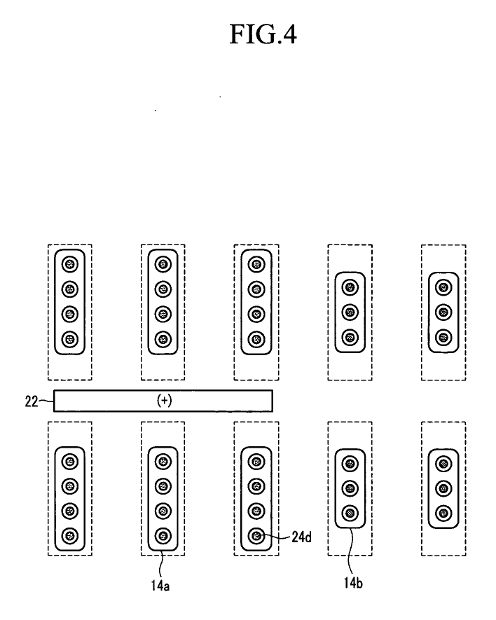

FIG. 4 is a partial top view of an electron emission display according to another embodiment of the present invention. Referring to FIG. 4, an electron emission region 24d is added in a portion of an opening 14a far from a spacer 22 in each opening 14a. When the spacer 22 is charged with positive electric charges, the electron beam may be attracted by the spacer 22 so as not to strike the target phosphor layer. However, in this embodiment, since the electron emission region 24d is added at the portion far from the spacer 22, the electron beam can land on the target phosphor layer.

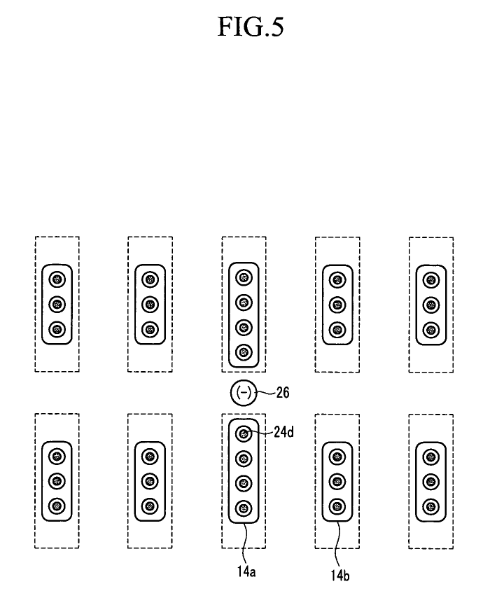

FIG. 5 is a partial top view of an electron emission display according to another embodiment of the present invention. In this embodiment, a spacer 26 is formed in a cylindrical shape and an electron emission region 24d is added in the case where the spacer 26 is charged with negative electric charges. The spacer 26 may be disposed between two openings facing each other.

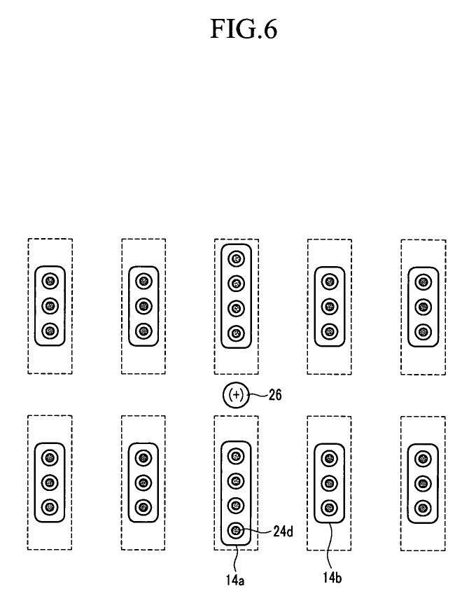

FIG. 6 is a partial top view of an electron emission display according to another embodiment of the present invention. In this embodiment, a spacer 26 is formed in a cylindrical shape and an electron emission region 24d is added in the case where the spacer 26 is charged with positive electric charges. The spacer 26 may be disposed between two openings facing each other.

In the foregoing embodiments, a case where the holes are formed in the first insulation layer 8 and the gate electrodes 10 such that the holes correspond to respective electron emission regions 24 is described. However, the present invention is not limited thereto. For example, slots may be formed in the first insulation layer 8 and the gate electrodes 10 such that each slot can expose the electron emission regions 24 in each unit pixel area.

Although the foregoing embodiments describe examples where the present invention is applied to only the electron emission display having an array of FEA elements, aspects of the present invention can also be applied to an electron emission display having an array of SCE elements, MIM elements or MIS elements.

According to aspects of the present invention, since an electron emission region is additionally added for each unit pixel area, the non-emission area of the phosphor layer, which may be formed by the electron beam distortion caused by the charging of the spacers, can be reduced. Therefore, the luminance and light emission uniformity of the electron emission display can be enhanced and the abnormal light emission around the spacers can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission display, comprising:
first and second substrates facing each other;
a plurality of phosphor layers formed on one substrate of the first and second substrates;
a plurality of electron emission regions formed on another substrate of the first and second substrates at each of unit pixel areas to correspond to the phosphor layers; and
a plurality of spacers disposed between the unit pixel areas to maintain a predetermined gap between the first and second substrates,
wherein the number of the electron emission regions in each unit pixel area adjacent to each spacer is greater than that of the electron emission regions in each unit pixel area that is not adjacent to any of the spacers.

2. The electron emission display of claim 1, wherein the electron emission regions in each unit pixel area adjacent to each spacer include main electron emission regions and at least one additional electron emission region.

3. The electron emission display of claim 2, wherein the additional electron emission region is added while maintaining a same shape and distances between respective electron emission regions and openings as those of the main electron emission regions.

4. The electron emission display of claim 3, wherein the additional electron emission region is added to each unit pixel area adjacent to each spacer at a portion of the unit pixel area near the spacer.

5. The electron emission display of claim 3, wherein the additional electron emission region is added to each unit pixel area adjacent to each spacer at a portion of the unit pixel area far from the spacer.

6. The electron emission display of claim 5, wherein electrons emitted from the electron emission regions land on corresponding phosphor layers.

7. The electron emission display of claim 2, wherein the phosphor layers comprise red, green and blue phosphor layers corresponding to the respective unit pixel area, the red, green and blue phosphor layers being divided from each other by a black layer.

8. The electron emission display of claim 7, wherein the additional electron emission region is formed to correspond to the black layer.

9. The electron emission display of claim 1, wherein the spacer is formed in a wall-shape.

10. The electron emission display of claim 1, wherein the spacer is formed in a cylindrical-shape.

11. The electron emission display of claim 1, wherein the electron emission region is formed of a material selected from the group consisting of carbon nanotubes, graphite, graphite nanofibers, diamonds, diamond-like carbon, C₆₀, silicon nanowires, and a combination thereof.

12. An electron emission display, comprising:
first and second substrates facing each other;
cathode and gate electrodes formed on the first substrate to cross each other and insulated from each other;
a plurality of electron emission regions connected to the cathode electrodes at crossed areas of the cathode and gate electrodes;
a focusing electrode formed above the cathode and gate electrodes, the focusing electrode being provided with openings for exposing the electron emission regions;
a plurality of phosphor layers formed on a surface of the second substrate facing the first substrate;
a plurality of spacers disposed between the openings to maintain a predetermined gap between the first and second substrates,
wherein the number of the electron emission regions formed in each opening adjacent to each spacer is greater than that of the electron emission regions formed in each opening that is not adjacent to any of the spacers.

13. The electron emission display of claim 12, wherein the cathode electrodes are disposed above the gate electrodes.

14. The electron emission display of claim 12, wherein the gate electrodes are disposed above the cathode electrodes.

15. The electron emission display of claim 12, wherein the electron emission regions in each opening adjacent to each spacer include main electron emission regions and at least one additional electron emission region.

16. The electron emission display of claim 15, wherein a size of each opening adjacent to each spacer is greater than that of each opening that is not adjacent to any of the spacers.

17. The electron emission display of claim 15, wherein the additional electron emission region is added while maintaining a same shape and distances between respective electron emission regions and openings as those of the main electron emission regions.

18. The electron emission display of claim 17, wherein the additional electron emission region is added to each opening adjacent to each spacer at a portion of the opening near the spacer.

19. The electron emission display of claim 17, wherein the additional electron emission region is added to each opening adjacent to the spacer at a portion of the opening far from the spacer.

20. The electron emission display of claim 12, wherein the spacer is formed in a wall-shape extending in a direction parallel to one of the cathode and gate electrodes.

21. The electron emission display of claim 12, wherein the spacer is formed in a cylindrical-shape and disposed between two openings.

22. The electron emission display of claim 15, wherein the electron emission region is formed of a material selected from the group consisting of carbon nanotubes, graphite, graphite nanofibers, diamonds, diamond-like carbon, C₆₀, silicon nanowires, and a combination thereof.

23. An electron emission display, comprising:
a plurality of electron emission regions formed on a substrate in unit pixel areas to emit a plurality of electron beams;
a light emission unit on a facing substrate coupled to an electron emission device to display an image when impinged by the electron beams, wherein the light emission unit comprises an anode electrode to accelerate the electron beams;
a plurality of spacers disposed between some of the unit pixel areas to maintain a predetermined distance between the electron emission device and the light emitting unit,
wherein the number of the electron emission regions in each unit pixel area is determined to correct distortion of the image by disruption of an electric field created by the anode electrode to accelerate the electron beams.

24. The electron emission display of claim 23, wherein the electron emission regions comprise elements selected from the group consisting of Field Emitter Array elements, Surface Conduction Emitter elements, Metal-Insulator-Metal elements, and Metal-Insulator-Semiconductor (MIS) elements.
